(19) United States
(12) Patent Application Publication
(10) Pub. No.: US 2024/0100495 A1
(43) Pub. Date: Mar. 28, 2024

(54) PROCESS FOR CARRYING OUT REACTIONS ON PREHEATED PARTICLES

(71) Applicants: HTE GmbH The High Throughput Experimentation Company, Heidelberg (DE); Consejo Superior de Investigaciones Cientificas (CSIC), Madrid (ES); Universitat Politecnica de Valencia (UPV), Valencia (ES)

(72) Inventors: Marius Kirchmann, Heidelberg (DE); Edgar Jordan, Heidelberg (DE); Alfred Haas, Heidelberg (DE); Sascha Hubert Vukojevic, Ludwigshafen (DE); Michael Dejmek, Heidelberg (DE); Oliver Koechel, Heidelberg (DE); Avelino Corma, Valencia (ES)

(21) Appl. No.: 17/768,924

(22) PCT Filed: Oct. 16, 2020
(86) PCT No.: PCT/EP2020/079254

§ 371 Date: Apr. 14, 2022

(30) Foreign Application Priority Data
Oct. 18, 2019 (EP) 19204163.0

(51) Int. Cl. B01J 8/08; B01J 8/00; C10G 11/16

(52) U.S. Cl. CPC B01J 8/087; B01J 8/0015; C10G 11/16; B01J 2208/00292; B01J 2208/00752

(57) ABSTRACT

The invention relates to a process for carrying out reactions on preheated particles, comprising: (a) providing particles in a buffer container; (b) feeding the particles from the buffer container into a reactor via a feed line; (c) withdrawing the particles from the reactor, wherein the particles are heated in the feed line.

The invention relates to a process for carrying out reactions on preheated particles.

Reactions with preheated particles are for example catalytic cracking reactions like fluid catalyzed cracking (FCC) for producing fuel and liquefied petroleum gas (LPG) from vacuum gas oil (VGO) or long chain hydrocarbons. For these reactions, the particles contain a catalyst for the fluid catalyzed cracking reaction. Another type of reaction carried out on preheated particles with an emphasis on thermal activation of molecules is pyrolysis.

These reactions are generally carried out at temperatures above 500° C. This reaction temperature can be achieved by heating the particles to a temperature which at least corresponds to the reaction temperature. During such reactions, coke deposits on the solid particles and can be used in a reactor-regenerator configuration to preheat the particles by combustion of the coke deposits in the regenerator.

In case a hydrocarbon feed is used which generates an insufficient amount of coke, the temperature which can be achieved by combusting the coke in the regenerator remains too low and it is necessary to further preheat the particles. For this purpose, for example torch oils are added to the reaction feed from which the necessary coke is formed. Further, newer processes for producing olefins or pyrolysis application are carried out at higher reaction temperatures which require higher particle temperatures and can be too high for being handled in a regenerator. Therefore, it is necessary to buffer and regenerate the particles at temperatures which are lower than the reaction temperatures and to supply additional heat between the regenerator and the reactor.

US-A 2005/0003552 describes a test unit for the study of particles in short contact time reactions between the particles and the reagents. The test unit comprises a buffer container for the particles, a reactor and a separator. In the buffer container the particles are stored and preheated. The preheated particles then flow through a load line which can be closed by a valve into the reactor. The reactor is followed by a separator to separate the particles from the reaction products. However, the maximum temperature to which the catalyst can be preheated is determined by the material the buffer container and the valve.

It is an object of the present invention to provide a process for carrying out reactions on preheated particles which allows to feed the particles into the reactor with a temperature which is above the temperature to which the particles can be preheated in a buffer container and which optionally allows to regenerate a catalyst which is comprised on the particles at lower temperatures.

This object is achieved by a process for carrying out reactions on preheated particles, comprising:
(a) providing particles in a buffer container;
(b) feeding the particles from the buffer container into a reactor via a feed line;
(c) withdrawing the particles from the reactor,
wherein the particles are heated in the feed line.

Depending on the reaction carried out, the particles used in the process for example are catalyst comprising particles. In this case, the particles may consist of a catalytic active material or may comprise a catalytic active material on a support. For fluid catalytic cracking, the particles for example are composite materials comprising a matrix and/or a binder or zeolite which additionally may comprise rare earth metals as catalytic active material. Suitable matrix materials and binder materials for example are silicon oxides or aluminum oxides like sand, silica, kaolin or quartz.

For reactions which are carried out at high temperatures but do not require a catalyst for example pyrolysis, the material for the particles preferably is selected such that the particles can be heated to the desired temperatures and store the heat. Suitable materials for example are silicon oxides or aluminum oxides like sand, silica, kaolin, quartz or zeolites.

By heating the particles in the feed line, it is possible to feed the particles into the reactor with a temperature which is above the temperature to which the particles can be preheated in the buffer container. Further it is possible to store the particles in the buffer container at a temperature which allows a regeneration of the catalyst.

The particles used in the reaction for example can be in the form of a powder or in the form of granules or pellets. To operate the process, it is necessary that the particles can be transported from the buffer container through the feed line into the reactor. Usually, for transportation the particles can be fluidized, for example by using an inert gas. The form and the type of the particles thereby depend on the reaction carried out in the reactor.

If the reaction is a cracking or pyrolysis reaction in which coke is a by-product, usually the coke deposits on the particles. This allows for supplying a part of the heat needed for the reaction by combusting the coke. The additional heat needed for heating the particles to a required temperature can be supplied by any suitable heating means known to a skilled person. Such heating means for example can be an internal or external heater. An internal heater for example can be a heating element like a heating conductor. Further it is also possible to supply heat by heating the walls of the feed line, for example by electrical heating elements which enclose the feed line or by conduction with high current and low voltage. As an alternative it is also possible to heat the particles in the feed line by inductive heating as far as the particles or the material of the feed line are susceptible to induction.

The temperature to which the particles are heated in the feed line preferably is in the range from 400 to 1200° C., more preferred in the range from 500 to 1000° C. and particularly in the range from 600 to 900° C. Heating the particles to such a temperature for example allows for carrying out an endothermic reaction like a catalytic cracking reaction, particularly a fluid catalytic cracking reaction, or a pyrolysis application in the reactor.

Preferably, for heating the particles a combustible and an oxidant are added and the heat is supplied by combustion of the combustible and the oxidant. By the combustion of the combustible and the oxidant it is possible to achieve a uniform heating of the particles and particularly to heat the particles to a temperature which allows to supply enough heat to the reaction without additional heating of the reactor.

To achieve such a temperature, it is preferred that the amount of combustible added is selected such that the specific heat output P/(m·ΔT) with “P” being the heating power in Watt, “m” the amount of particles in kilograms and “ΔT” the intended temperature increase in Kelvin is in a range from 5 to 50 W/(kg·K), more preferred in a range from 8 to 30 W/(kg·K) and particularly in a range from 10 to 25 W/(kg·K).

Further it also might be necessary to supply enough heat and to heat reactants to such a temperature if such a temperature is needed as starting temperature of an exothermic reaction. In case of an exothermic reaction, however, it is preferred to use the heat released during the exothermic reaction to heat the particles. This has the advantage that no additional heat must be supplied to the process.

However, the inventive process particularly is used for reactions which are carried out at temperatures in the range from 400 to 1000° C., for example catalytic cracking reactions like fluid catalytic cracking (FCC) or high temperature pyrolysis applications.

The reactor used in the inventive process can be any reactor which allows a continuous reaction. Preferably, the reactor is a tubular reactor comprising of an entrained flow of particles such as a riser or down-flow reactor. Further, a fluidized-bed reactor operating in a reactor-regenerator configuration can profit from additional pre-heat between regenerator and reactor.

Heating the particles to a temperature above the temperature at which the reaction is carried out, allows to supply all heat needed for carrying out the reaction by the heated particles. This has the additional advantage that a more uniform heat distribution in the reactor is achieved. Further, for reactions which have to be carried out in an inert atmosphere, particularly in an atmosphere which does not contain oxidants, it is not possible to supply heat in the reactor by combustion because the oxidant which is used for combustion also would affect the reaction and usually the heating power of internal or external heaters is not sufficient to supply enough heat for carrying out such reactions.

To avoid feeding undesired byproducts from the combustion for heating the particles into the reactor, it is preferred to use combustibles which can be converted totally into water, carbon monoxide and carbon dioxide and do not form further combustion products. Suitable combustibles for example are selected from the group consisting of hydrogen, methane, ethane, propane and butane and combinations thereof such as dry gas (generally C1 and C2 hydrocarbons) or LPG (generally C3 and C4 hydrocarbons). The advantage of using combustibles only forming water, carbon monoxide and carbon dioxide by combustion is that these compounds are inert in regard to the cracking reaction. Further, hydrogen, methane, ethane, propane and butane usually do not form coke if not combusted completely. In case of catalytic reactions, this coke could deposit on the catalyst comprising particles which would decrease the efficiency of the catalyst.

The oxidant used for the combustion to heat the particles can be any suitable oxidant which should be utilized out of the explosion limits. To avoid the formation of undesired by-products, it is particularly preferred to use an oxygen comprising gas as oxidant, for example air, diluted air, oxygen enriched air, oxygen or a mixture of oxygen and an inert gas. Particularly preferable oxygen is used as oxidant. By using oxygen as oxidant no further gases contained in the oxygen comprising gas must be heated and particularly no further gases are fed into the reactor which might affect the chemical reaction.

If a mixture of oxygen and an inert gas is used as oxidant, the inert gas preferably is nitrogen, argon, steam or a mixture thereof.

Particularly for being used for reactions which shall be carried out without additional oxygen to avoid forming of by-products or where no oxygen shall be added for safety reasons, it is preferred to add the oxidant substoichiometrically. By adding the oxidant substoichiometrically, it is ensured that the complete oxidant reacts with the combustible during the combustion. Thus, no oxidant is fed into the reactor. The amount of oxidant added preferably is in the range from 10 to 100%, more preferred 30 to 90% and particularly from 50 to 90%, where 100% means the stoichiometric amount of oxidant for the combustion of the combustible.

To avoid agglomeration of the particles and/or plugging of the particles in the feed line, it is preferred to fluidize the particles by feeding a gas into the flow direction of the particles into the feed line. If the particles are heated by an external or internal heater, the gas preferably is an inert gas in regard to the reaction carried out in the reactor, to avoid a negative effect on the reaction from gas which might be entrained with the particles.

If the particles are heated by combustion of the added combustible and oxidant, it is particularly preferred that the combustible and the oxidant are fed into the feed line in gaseous form.

In the context of the present invention, the term “feed line” refers to the feed line for particles which are preheated in the feed line. The feed line generally is not directly connected to the entrance of the reactor, because the entrance of the reactor is connected to a reactant feed.

The temperature to which the particles are heated in the feed line depends on the chemical reaction in the reactor and thereby to the temperature at which this reaction is carried out. If no further heat can be supplied to the reactor or a uniform temperature distribution in the reactor shall be kept, the temperature of the particles must be high enough to supply the energy which is necessary for carrying out the reaction. This is particularly important for endothermic reactions where heat must be supplied to avoid stopping of the reaction. On the other hand, for exothermic reactions it is only important to provide the necessary starting temperature as in an exothermic reaction after starting the reaction no further heat must be supplied. To the contrary, for an exothermic reaction usually heat must be dissipated.

For continuing the reaction, particles are withdrawn from the reactor in the same amount as fed into the reactor by the feed line. The withdrawal point of the particles and the connection of the feed line to the reactor thereby preferably are at opposite ends of the reactor. The particles withdrawn from the reactor either can be discharged from the process or, preferably, reused.

To reuse the particles, the particles are separated from the reaction products and preferably recycled into the buffer container after being withdrawn from the reactor. From the buffer container the recycled particles then can flow into the feed line where it is heated and from the feed line into the reactor to be reused.

To reduce aging of the particles while it is buffered in the buffer container it is preferred to buffer the particles at a temperature which is below the temperature of the particles in the reactor. Particularly if catalyst containing particles are used, it is preferred that the temperature in the buffer container is set such that it allows the catalyst to regenerate. If necessary, it is further possible to add a regeneration medium into the buffer container to improve regeneration of the catalyst. Such a regeneration medium depends on the type of catalyst used in the reaction and is well known to a skilled person. A typical regeneration medium for example is air.

If no regeneration medium is used it further is advantageous to provide an inert atmosphere in the buffer container. Such inert atmosphere ensures that the particles do not age in the buffer container. An inert atmosphere can be provided for example by flooding the buffer container with an inert gas, for example with nitrogen or a noble gas like argon. Particularly preferred, the inert gas is nitrogen.

For bringing all of the catalyst comprising particles in the buffer container in contact with the regeneration medium, it is preferred to intimately mix the catalyst comprising particles with the regeneration medium. For gaseous regeneration media it is particularly preferred to feed these from below and generate a fluidized bed in the buffer container by feeding the regeneration medium. In such a fluidized-bed, all catalyst comprising particles come into contact with the regeneration medium.

If it is not necessary to regenerate the particles or it is only necessary to buffer the particles at a lower temperature, no additional substances are fed into the buffer container and the temperature is set such that no aging of the particles occurs in the buffer container or if the particles regenerate without adding further substances the temperature is set such that the particles regenerate. The temperatures at which aging is avoided and/or at which the particles regenerates also are well known to a skilled person. Usually, the temperature of the particles in the buffer container is in the range from 400 to 850° C., more preferred in the range from 500 to 800° C. and particularly in the range from 650 to 750. Keeping the temperature in such a range in the buffer container has the additional advantage that the amount of heat which must be supplied to the particles in the feed line to achieve the required temperature with which the particles shall be fed into the reactor can be minimized. If heating is carried out by combustion of the combustible and the oxidant, thus the amount of combustible and oxidant can be reduced to a minimum by which also the amount of impurities which result from the combustion and are fed into the reactor is minimized.

Another advantage of keeping the temperature in the above identified range is that the buffer container and a corresponding valve through which the particles are fed into the feed line can be made from standard materials like steel and it is not necessary to use special materials which are particularly heat-resistant to achieve enough life time of the buffer container.

After being withdrawn from the reactor, the particles must be separated from the other media which are withdrawn from the reactor, particularly from the reaction product and—if present—from reactants which did not react.

For separating the particles from the other media, a separator can be used. If the reaction is a catalytic cracking reaction, only the particles are solid and all other media are gaseous. For separating the particles from the further media, therefore, a gas-solid separation apparatus can be used. Such gas-solid separation apparatus for example are cyclones. Alternatively, it is also possible to use a container into which the particles and the reaction media are fed. In the container, the particles are collected in the bottom and the gaseous media can be withdrawn from the top. However, to avoid particles being withdrawn with the gaseous media, it is preferred to use a gas-solid separation apparatus which removes the solids from the gas like a cyclone.

From the gas-solid separation apparatus the solids are withdrawn by a suitable conveying means, for example a rotary feeder. The thus removed solids which comprise the solid particles then can be recycled into the buffer container for regeneration and reuse of the particles. Alternatively, it is also possible to withdraw the solids from the process and to dispose them.

To remove impurities which may deposit on the particles, it is further possible to only recycle a part of the particles into the buffer container and to withdraw the rest of the solids from the process.

The gaseous reaction media withdrawn from the process can be used for further processes or can be worked up, depending on the reaction carried out in the reactor and the thus obtained reaction media.

Particularly, in further process steps, the obtained reaction product can be treated further, for example by separating the obtained reaction product from impurities, by-products and reagents which did not react.

The process particularly is suitable for being used in a test unit. Such a test unit comprises a reactor which is connected by a feed line with a buffer container which contains particles. The buffer container of such a test unit preferably has a capacity for the uptake of particles which is in a range from 0.15 to 15 L, more preferred in a range from 0.2 to 10 L. The particles used in the test unit preferably have a particle diameter which is in a range from 20 to 300 μm.

The feed line for the transfer of the particles from the buffer container to the reactor in such a test unit preferably has a length in the range from 0.3 to 5 m, particularly in a range from 0.5 to 2 m, and an inner diameter in a range from 0.2 to 2 cm, particularly in a range from 0.3 to 1.5 cm. The feed line preferably is positioned in such a way that its longitudinal axis has an angle in the range from 30° to 90° with respect to the horizontal, preferably the angle is in the range from 40° to 70°. The slope of the feed line allows that the supply of the catalyst is better controlled over a vertical arrangement. In case that the feed line is 0.6 m or longer it is preferred that the feed line has a spiral shape in order to provide a space saving set-up.

The reactor of the test unit preferably is a tube reactor having a length in a range from 0.3 to 3 m and more preferred in a range from 0.5 to 2 m. The inner diameter of the tube reactor preferably is in a range from 0.3 to 2 cm, more preferred in a range from 0.5 to 1.8 cm and particularly in a range from 0.6 to 1.5 cm, wherein it is preferred that the feed line has a smaller diameter than the reactor.

For heating the particles in the feed line, it is preferred to use a heating device which is arranged in direct proximity to the outer part of the feed line.

Generally, the individual parts of the unit are separated from each other and the buffer container and the feed line do not form an integral part of the reactor. The separate components may be connected by means which are known to a person skilled in the art. The components for example may be connected by screw connections or welding.

If the process is used in a test unit, it is further possible to analyze the reaction product by usual analyzing methods like chromatographic methods or spectrometric methods, for example gas chromatography or infrared spectroscopy. Of course, all further analytic methods for analyzing the reaction product can be used. Suitable processes for analyzing the reaction product for example are disclosed in US-A 2005/0003552.

Illustrative embodiments of the invention are shown in the accompanying figures and are explained in the following description.

In the drawing:

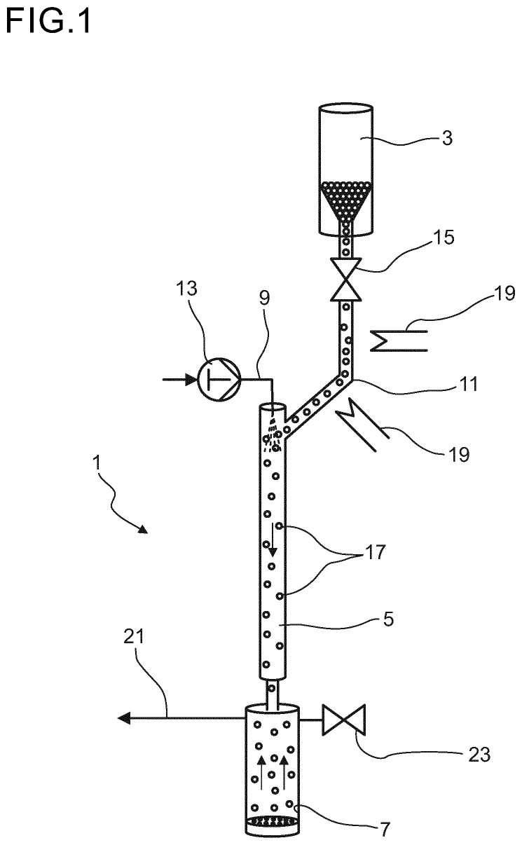

FIG. 1 shows a laboratory test unit for operating the process for carrying out reactions on preheated particles;

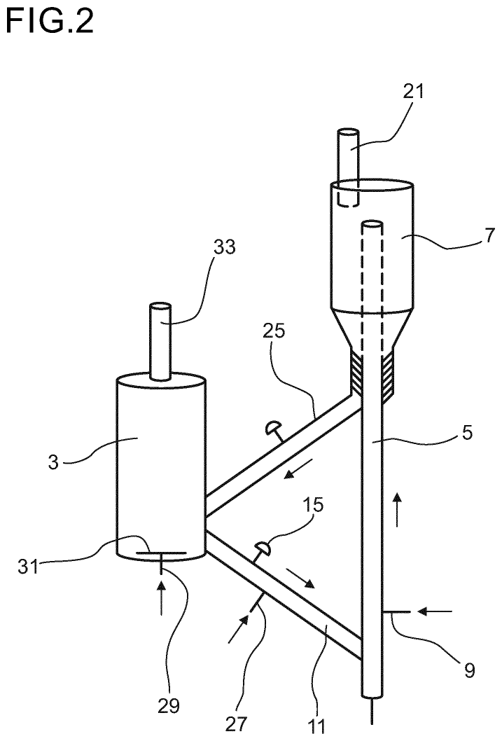

FIG. 2 shows an apparatus for operating the process for carrying out reactions on preheated particles in a second embodiment.

FIG. 1 shows a test unit for operating the process for carrying out reactions on preheated particles.

A test unit 1 for operating the process for carrying out reactions on preheated particles in the gas phase comprises a buffer container 3 for the particles a reactor 5 and a separator 7 in which the reaction mixture is separated from the solid particles.

For carrying out the reaction in the reactor 5, liquid or gaseous reactants are fed into the reactor via reactant feed 9. Further, the buffer container 3 is connected to the reactor by a feed line 11. When the test unit is operated, at least one reactant is fed into the reactor 5 via the reactant feed 9.

To support feeding the at least one reactant into the reactor 5 a suitable gas or liquid conveying device, for example a pump 13 or a compressor may be used. The gas or liquid conveying device may be any pump or compressor which allows transport of the at least one reactant into the reactor. If the at least one reactant is preheated, usually a gas or liquid conveying device is used which is resistant towards the temperature of the at least one reactant flowing through the gas or liquid conveying device.

To feed the particles into the reactor, additionally valve 15 is opened. By opening valve 15 particles 17 flows from the buffer container 3, through the feed line 11 into the reactor 5.

The reactor 5 in the embodiment shown in FIG. 1 is a tubular reactor through which at least one reactant and the particles flow in co-current from top to bottom. Thus the flow of the particles and the at least one reactant in the reactor 5 is supported by gravity.

According to the invention, the particles are preheated in the feed line 11 to a temperature which is above the temperature of the reaction to be carried out in the reactor before entering the reactor 5. By preheating the particles before entering the reactor 5 it is for example possible to provide necessary energy which is used as starting energy for an exothermic reaction or energy which is used to operate an endothermic reaction in the reactor 5. For heating the particles 17, any suitable heating means 19 can be used. A suitable heating means 19 for example is an internal heater like a heating conductor. A suitable external heater for example is realized by heating the walls of the feed line 11, for example by electrical heating elements which enclose the feed line 11. Further, the heating means 19 also may comprise an inductive heating of the particles in the feed line 11 which affords that the particles or the feed line is susceptible to induction. To obtain particles susceptible to induction, it is for example possible to provide particles having a magnetizable support. Besides heating the particles by a heating means 19 it is also possible and particularly preferred to heat the particles by feeding a combustible and an oxidant into the feed line 11. In the feed line 11 the combustible reacts with the oxidant and thereby heat is generated.

The temperature to which the particles are heated depends on the reaction which shall be carried out in the reactor 5. Preferably, the particles are heated to a temperature which is 0 to 500° C. above the temperature in the reactor, preferably 100 to 400° C. above the temperature in the reactor and particularly 100 to 300° C. above the temperature in the reactor. If the reaction is a fluid catalytic crack reaction, the temperature to which the particles are heated preferably is in the range from 150 to 200° C. above the reactor temperature.

After flowing through the reactor 5, the gaseous reaction mixture and the particles flow into the separator 7. In the separator 7 the gaseous reaction mixture is separated from the solid particles. In the embodiment shown in FIG. 1, the solid particles are collected in the separator 7 and the gaseous reaction product is withdrawn via exit line 21. The gaseous reaction product then can be transported to a unit for further processing, for example to remove impurities from the reaction product and if only a part of the at least one reactant is transformed, separating the product from the non-reacted reactant. Further, also an analysis can take place for analyzing the reaction product.

The particles collected in the separator also can be removed. To remove the particles, a valve 23 is provided which is opened to remove the particles from the separator 7. Preferably, to remove the particles, an inert gas flows through the particles forming a fluidized bed and the particles are removed from the top of the fluidized bed. A suitable inert gas for example is nitrogen.

After being removed from the separator, the particles can be collected in a device for particle recovery and optionally regenerated externally. After being worked-up in the particle recovery, the particles can be recycled into the buffer container 3 and be reused.

As clearly can be seen in FIG. 1, the individual parts of the test unit 1 are separated from each other and the buffer container 3 and the feed line 11 do not form an integral part of the reactor 5. The separated components may be connected by means which are known to the person skilled in the art. The components may by connected by screw connections or welding. The term feed line 11 refers to the feed line 11 for preheated particles which are preheated in the particles feed line. The entrance of the reactor 5 is connected to the reactant feed 9 which supplies the reactant.

Preferably, the test unit 1 is used in the laboratory scale or scale of a small pilot plant. Thereby, the buffer container 3 preferably has a capacity for the uptake of particles which is in the range from 0.15 to 15 Liters, more preferred in a range from 0.2 to 10 Liters.

The feed line 11 for the transfer of particles from the buffer container 3 to the reactor 5 preferably has a length in a range from 0.3 to 5 m, whereby a length from 0.5 to 2 m is further preferred. Preferably the inner diameter of the feed line 11 is in a range from 0.2 to 2 cm, more preferred in a range from 0.3 to 1.5 cm. Heating of the particles in the feed line 11 particularly preferably is based on the use of a heating device which is arranged in direct proximity to the outer part of the feed line 11.

It is preferred that the reactor 5 has a length in a range from 0.3 to 3 m, more preferred the reactor 5 has a length in a range from 0.5 to 2 m. The inner diameter of the reactor preferably is in a range from 0.3 to 2 cm, more preferred in a range from 0.5 to 1.8 cm, and particularly in a range from 0.7 to 1.5 cm.

In order to carry out the process according to the invention it is preferred that the particles which are employed within the process have a mean particle diameter which is in a range from 20 to 300 μm.

FIG. 2 shows an apparatus for operating the process for carrying out reactions on preheated particles in a second embodiment.

The embodiment shown in FIG. 2 particularly differs from the embodiment of FIG. 1 in that according to FIG. 2 the particles circulate. Further, the reactor 5 in the embodiment shown in FIG. 2 is a riser reactor in which the gas and the particles flow from the bottom to the top contrary to the direction of gravity. To operate the reactor of the embodiment in FIG. 2, the velocity of the reactants and the resulting reaction mixture obtained by the reaction in the reactor 5 must be sufficiently high to transport the particles through the reactor 5.

The particles are provided in the buffer container 3 and flows from the buffer container 3 through the feed line 11 into the reactor 5. The buffer container 3 preferably also acts as regenerator for the particles. In the feed line 3 the particles are heated by a suitable heating means which may correspond to the heating means 19 described above for the embodiment shown in FIG. 1. However, particularly preferably the particles are heated by feeding a combustible, for example methane, ethane, propane, butane or hydrogen, and an oxidant, for example oxygen, into the feed line 11 via a feed line 27 for the combustible. By oxidation of the combustible the particles are heated in the feed line. The amount of combustible and oxidant is selected such that the total amount of oxidant reacts with the combustible in the feed line 11 to avoid oxidant being fed into the reactor 5, as particularly in a catalytic cracking reaction the oxidant has a negative impact on the cracking reaction forming undesired by-products, particularly carbon monoxide.

From the reactor 5, the reaction mixture and the particles flow into the separator 7 which also may be called “stripper”. In the separator 7 the reaction product is separated from the solid particles. To separate the particles from the reaction product, the separator 7 for example can be a cyclone.

In the embodiment shown in FIG. 2, the solid particles collects at the bottom of the separator 7 and is transported from the separator 7 via a connecting line 25 into the buffer container 3. The temperature in the buffer container 3 is below the reaction temperature to allow the catalyst to regenerate in the buffer container 3. To support regeneration of the catalyst in the buffer container 3, a gas, for example air, can be added to the buffer container 3 via a gas feed line 29. The gas preferably is added via a suitable gas distributor 31 to generate a fluidized bed in the buffer container 3. By this fluidized bed it can be ensured that all catalyst particles can come into contact with the gas. Further, by generating a fluidized bed it can be avoided that particles agglomerate.

To keep the pressure in the buffer container 3 constant, an exhaust line 33 is connected to the buffer container 3 through which flue gas can be withdrawn. If necessary, the flue gas can be subjected to a waste gas treatment and then either collected or emitted to the environment.

For the circulation of the particles, the apparatus shown in FIG. 2 particularly is suitable for being used in industrial scale processes whereas the apparatus shown in FIG. 1 particularly is used as a test unit for experimentation.

### LIST OF REFERENCE NUMERALS

1 test unit
3 buffer container
5 reactor
7 separator
9 reactant feed
11 feed line
13 pump
15 valve
17 particles
19 heating means
21 exit line
23 valve
25 connecting line
27 feed line for the combustible
29 gas feed line
31 gas distributor
33 exhaust line

1. A process for carrying out reactions on preheated particles, comprising:
(a) providing particles in a buffer container;
(b) feeding the particles from the buffer container into a reactor via a feed line, which is not directly connected to the entrance of the reactor, and feeding reactants via a reactant feed, which is connected to the entrance of the reactor;
(c) withdrawing the particles from the reactor,
wherein the particles are heated in the feed line.

2. The process according to claim 1, wherein for heating the particles a combustible and an oxidant are added and the particles are heated by combustion of the combustible and the oxidant.

3. The process according to claim 2, wherein the combustible is selected from the group consisting of hydrogen, methane, ethane, propane and butane.

4. The process according to claim 2, wherein the oxidant is an oxygen comprising gas.

5. The process according to claim 4, wherein the oxygen comprising gas is air, diluted air, oxygen enriched air, oxygen or a mixture of oxygen and an inert gas.

6. The process according to claim 2, wherein the oxidant is added sub stoichiometrically.

7. The process according to claim 2, wherein the combustible and the oxidant are fed into the feed line in counter current to the flow direction of the particles.

8. The process according to claim 1, wherein the particles are heated in the feed line to a temperature in the range from 400 to 1200° C.

9. The process according to claim 1, wherein after being withdrawn from the reactor, the particles are recycled into the buffer container.

10. The process according to claim 1, wherein the particles are regenerated in the buffer container.

11. The process according to claim 1, wherein the temperature of the particles in the buffer container is in the range from 400 to 850° C.

12. The process according to claim 1, wherein the reaction on preheated particles is a catalytic cracking reaction.

13. The process according to claim 1, wherein the reaction on preheated particles is a pyrolysis reaction.
